(19) United States
(12) Patent Application Publication
(10) Pub. No.: US 2012/0285569 A1
(43) Pub. Date: Nov. 15, 2012

(54) Faucet that can be Assembled Easily and Quickly

(76) Inventor: Gary Wu, Homei Township (TW)

(21) Appl. No.: 13/105,956

(22) Filed: May 12, 2011

(51) Int. Cl. F16K 51/00

(52) U.S. Cl. 137/801

(57) ABSTRACT

A faucet includes a housing having an inner portion provided with a receiving space, a fixing plate affixed to the housing, a valve seat mounted in the receiving space of the housing and located between the housing and the fixing plate, a water control valve mounted between the housing and the valve seat, a pipe unit extended through the fixing plate and connected with the valve seat, and at least one retaining member secured on the pipe unit and located between the valve seat and the fixing plate to affix the pipe unit to the fixing plate so as to prevent the pipe unit from being detached from the valve seat. Thus, the pipe unit is directly inserted into the valve seat to decrease the working process of the valve seat and to decrease the costs of fabrication.

### BACKGROUND OF THE INVENTION

1. Field of the Invention

The present invention relates to a water supply and, more particularly, to a faucet to spray water.

2. Description of the Related Art

A conventional faucet comprises a housing, a valve seat mounted in the housing, a water control valve mounted between the housing and the valve seat to control a water output from the housing, a control handle pivotally mounted on the housing and connected with the water control valve to control operation of the water control valve, and a pipe unit connected with the water control valve via the valve seat to supply water into the housing. The pipe unit is usually made of metallic material, and the valve seat is also made of metallic material. Thus, the pipe unit may be connected with the valve seat by soldering. However, the pipe unit and the valve seat are made of metallic material, thereby increasing the cost of fabrication of the faucet. The valve seat may be made of plastic material to decrease the cost of fabrication. However, it is difficult to fit the valve seat made of plastic material with the pipe unit made of metallic material.

In addition, the valve seat is usually made of a copper alloy. Recently, many developed countries have strict standards to limit the amount of the heavy metal contained in the copper alloy so as to prevent pollution caused by the heavy metal. For example, according to the NSF standard of the USA and the 65 proposition of the state of California, the heavy metal, such as lead, contained in the material used by the faucet is limited, and the manufacturer has to use a copper alloy with greater components so that the cost of fabrication is increased largely. Thus, a plastic material with high strength is used to replace the copper alloy. The plastic material is integrally formed directly without needing a secondary working process, thereby decreasing the cost of fabrication. However, the plastic material cannot fit the metallic material so that the plastic material is not connected with the metallic material easily.

The first prior art reference was disclosed in U.S. Pat. No. 6,360,770, entitled “MODULAR LAVATORY FAUCET SPOUT MOUNTING”. However, many working procedures are needed in the working process of the housing of the faucet, thereby consuming much working time. In addition, the precision of the faucet is reduced largely during so many working procedures so that the faucet easily produces leakage.

The second prior art reference was disclosed in U.S. Pat. No. 5,349,987, entitled “FAUCET WITH A MOVABLE EXTENSION NOZZLE”. However, many working procedures are needed in the working process of the housing of the faucet, thereby consuming much working time. In addition, the precision of the faucet is reduced largely during so many working procedures so that the faucet easily produces leakage.

The third prior art reference was disclosed in U.S. Pat. No. 7,766,043, entitled “FAUCET INCLUDING A MOLDED WATERWAY ASSEMBLY”. However, when the faucet is assembled, the faucet needs many assembling steps, thereby causing inconvenience in assembly of the faucet, and thereby increasing the cost of assembly.

### BRIEF SUMMARY OF THE INVENTION

In accordance with the present invention, there is provided a faucet, comprising a housing having an inner portion provided with a receiving space, a fixing plate affixed to the housing, a valve seat mounted in the receiving space of the housing and located between the housing and the fixing plate, a water control valve mounted between the housing and the valve seat, a pipe unit extended through the fixing plate and connected with the valve seat, and at least one retaining member secured on the pipe unit and located between the valve seat and the fixing plate to affix the pipe unit to the fixing plate so as to prevent the pipe unit from being detached from the valve seat.

The primary objective of the present invention is to provide a faucet that can be assembled easily and quickly.

According to the primary advantage of the present invention, the end portion of the pipe unit is extended through the through hole of the fixing plate and is inserted into the guide hole of the valve seat so that the pipe unit is connected with the valve seat easily and quickly, thereby facilitating a user assembling the pipe unit and the valve seat.

According to another advantage of the present invention, the retaining member is located between the valve seat and the fixing plate to affix the pipe unit to the fixing plate so that the pipe unit is directly inserted into the valve seat to decrease the working process of the valve seat and to decrease the costs of fabrication.

According to a further advantage of the present invention, the retaining member is mounted in the retaining groove of the pipe unit and is located between the valve seat and the fixing plate so that the retaining member can connect the valve seat and the pipe unit of different material.

According to a further advantage of the present invention, the housing, the valve seat and the fixing plate are combined together by the locking bolts so that the valve seat and the pipe unit of different material are positioned by the retaining member without needing a secondary working process.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a faucet in accordance with the preferred embodiment of the present invention.

FIG. 2 is an exploded perspective view of the faucet as shown in FIG. 1.

FIG. 3 is an exploded perspective view of the faucet as shown in FIG. 1.

FIG. 4 is a partially side cross-sectional view of the faucet as shown in FIG. 1.

FIG. 5 is a locally enlarged view of the faucet as shown in FIG. 4.

FIG. 6 is an exploded perspective view of a faucet in accordance with another preferred embodiment of the present invention.

FIG. 7 is a partially side cross-sectional assembly view of the faucet as shown in FIG. 6.

FIG. 8 is an exploded perspective view of a faucet in accordance with another preferred embodiment of the present invention.

### DETAILED DESCRIPTION OF THE INVENTION

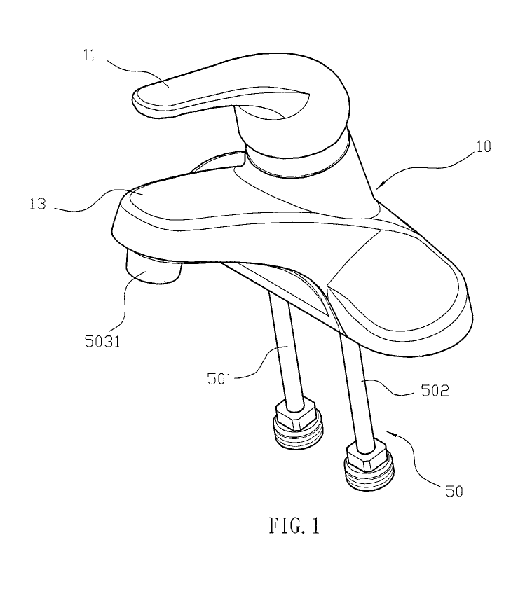

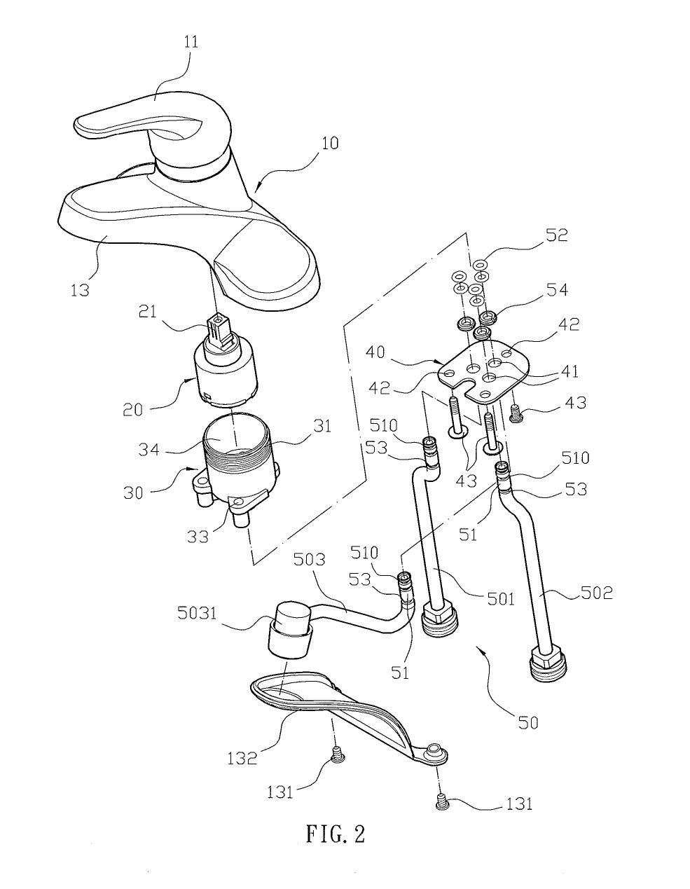

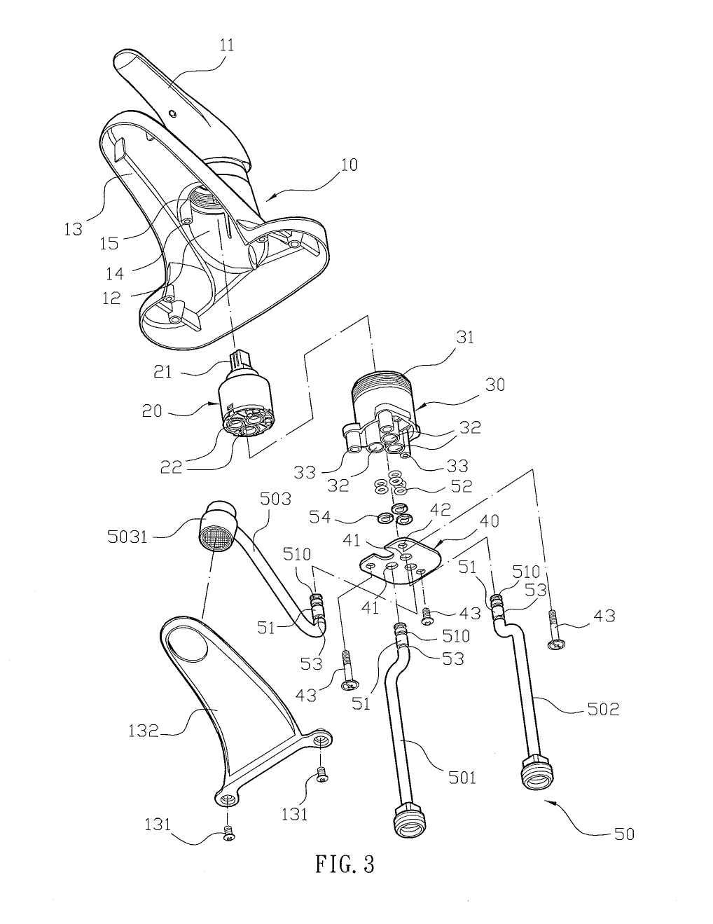

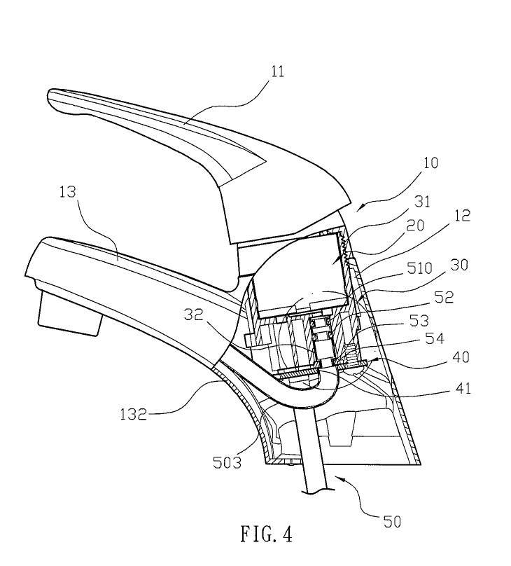

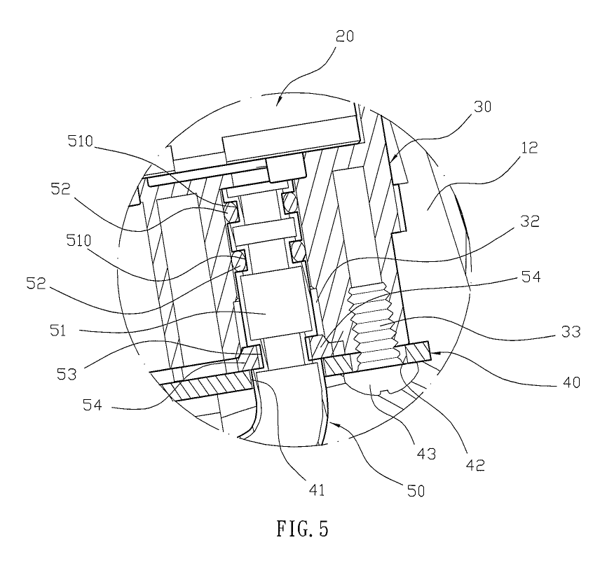

Referring to the drawings and initially to FIGS. 1-5, a faucet in accordance with the preferred embodiment of the present invention comprises a housing 10 having an inner portion provided with a receiving space 12, a fixing plate 40 affixed to the housing 10, a valve seat 30 mounted in the receiving space 12 of the housing 10 and located between the housing 10 and the fixing plate 40, a water control valve 20 mounted between the housing 10 and the valve seat 30, a control handle 11 pivotally mounted on the housing 10 and connected with the water control valve 20 to control operation of the water control valve 20, a pipe unit 50 extended through the fixing plate 40 and connected with the valve seat 30, and at least one retaining member 54 secured on the pipe unit 50 and located between the valve seat 30 and the fixing plate 40 to affix the pipe unit 50 to the fixing plate 40 so as to prevent the pipe unit 50 from being detached from the valve seat 30.

The housing 10 has a side provided with a water outlet portion 13 connected to the receiving space 12. The water outlet portion 13 of the housing 10 has an open bottom, and the faucet further comprises a bottom cover 132 mounted on the open bottom of the water outlet portion 13 by a plurality of fastening screws 131 to cover the water outlet portion 13 of the housing 10. The receiving space 12 of the housing 10 has a rim provided with a plurality of screw bores 14 and has a peripheral wall provided with an inner threaded portion 15.

The valve seat 30 is made of plastic material. The valve seat 30 has an inner portion provided with a receiving chamber 34 connected to the receiving space 12 of the housing 10 to receive the water control valve 20. The valve seat 30 has an end portion provided with at least one guide hole 32 to allow insertion of the pipe unit 50. The valve seat 30 has a rim provided with a plurality of locking holes 33 aligning with the screw bores 14 of the housing 10 respectively. The valve seat 30 has a peripheral wall provided with an outer threaded portion 31 screwed into the inner threaded portion 15 of the housing 10 to lock the valve seat 30 in the receiving space 12 of the housing 10.

The fixing plate 40 is made of metallic material. The fixing plate 40 has a surface provided with at least one through hole 41 aligning with the guide hole 32 of the valve seat 30 to allow passage of the pipe unit 50. The fixing plate 40 has a periphery provided with a plurality of fixing holes 42 aligning with the locking holes 33 of the valve seat 30 respectively, and the faucet further comprises a plurality of locking bolts 43 in turn extended through the fixing holes 42 of the fixing plate 40 and the locking holes 33 of the valve seat 30 respectively and screwed into the screw bores 14 of the housing 10 respectively so that the housing 10, the valve seat 30 and the fixing plate 40 are combined together by the locking bolts 43.

The pipe unit 50 is made of metallic material, such as a copper alloy and the like. The pipe unit 50 is extended through the through hole 41 of the fixing plate 40 into the guide hole 32 of the valve seat 30. The pipe unit 50 has an end portion 51 which is extended through the through hole 41 of the fixing plate 40 and is fully inserted into the guide hole 32 of the valve seat 30. The end portion 51 of the pipe unit 50 has a surface provided with at least one annular mounting groove 510 for mounting at least one O-ring 52 which is inserted into the guide hole 32 of the valve seat 30 and biased between the end portion 51 of the pipe unit 50 and the guide hole 32 of the valve seat 30 to provide an air-tight effect between the pipe unit 50 and the valve seat 30. The end portion 51 of the pipe unit 50 has a periphery provided with a retaining groove 53 for mounting the retaining member 54. The retaining groove 53 of the pipe unit 50 has an annular shape, and the retaining member 54 also has an annular shape.

The retaining member 54 is a C-shaped snap. The retaining member 54 is located between the guide hole 32 of the valve seat 30 and the through hole 41 of the fixing plate 40. The retaining member 54 has a size greater than that of the guide hole 32 of the valve seat 30 and greater than that of the through hole 41 of the fixing plate 40.

The water control valve 20 is located between the receiving space 12 of the housing 10 and the receiving chamber 34 of the valve seat 30. The water control valve 20 has a first end provided with a control shaft 21 which is driven by the control handle 11 and has a second end provided with at least one water inlet hole 22 aligning with and connected to the guide hole 32 of the valve seat 30, and the guide hole 32 of the valve seat 30 is connected between the water inlet hole 22 of the water control valve 20 and the pipe unit 50 so that the pipe unit 50 is connected to the water inlet hole 22 of the water control valve 20 through the guide hole 32 of the valve seat 30.

In the preferred embodiment of the present invention, the valve seat 30 has three guide holes 32, the water control valve 20 has three water inlet holes 22 aligning with the guide holes 32 of the valve seat 30 respectively, the fixing plate 40 has three through holes 41 aligning with the guide holes 32 of the valve seat 30 respectively, and the pipe unit 50 includes a hot water inlet pipe 501, a cold water inlet pipe 502 and a mixed water outlet pipe 503 each extended through a respective one of the through holes 41 of the fixing plate 40 into a respective one of the guide holes 32 of the valve seat 30. The mixed water outlet pipe 503 of the pipe unit 50 has a distal end provided with an aerator 5031 mounted in the water outlet portion 13 of the housing 10 and partially protruded outward from the bottom cover 132. The faucet comprises three retaining members 54 secured on the hot water inlet pipe 501, the cold water inlet pipe 502 and the mixed water outlet pipe 503 of the pipe unit 50 respectively.

In assembly, the water control valve 20 is placed into the receiving space 12 of the housing 10, and the control shaft 21 of the water control valve 20 is connected with the control handle 11. Then, the valve seat 30 is placed into the receiving space 12 of the housing 10 to surround the water control valve 20. Then, the outer threaded portion 31 of the valve seat 30 is screwed into the inner threaded portion 15 of the housing 10 to lock the valve seat 30 in the receiving space 12 of the housing 10 so that the water control valve 20 is located between the receiving space 12 of the housing 10 and receiving chamber 34 of the valve seat 30. Then, the end portion 51 of the pipe unit 50 is extended through the through hole 41 of the fixing plate 40. Then, the retaining member 54 is mounted in the retaining groove 53 of the pipe unit 50, and the O-ring 52 is mounted in the mounting groove 510 of the pipe unit 50. Then, the end portion 51 of the pipe unit 50 together with the O-ring 52 is inserted into the guide hole 32 of the valve seat 30 so that the pipe unit 50 is connected to the water inlet hole 22 of the water control valve 20 through the guide hole 32 of the valve seat 30. Then, the fixing plate 40 abuts the valve seat 30, and the fixing holes 42 of the fixing plate 40 align with the locking holes 33 of the valve seat 30 respectively. Then, the locking bolts 43 are in turn extended through the fixing holes 42 of the fixing plate 40 and the locking holes 33 of the valve seat 30 respectively and are screwed into the screw bores 14 of the housing 10 respectively so that the housing 10, the valve seat 30 and the fixing plate 40 are combined together by the locking bolts 43. At this time, the retaining member 54 is located between the valve seat 30 and the fixing plate 40 to affix the pipe unit 50 to the fixing plate 40 so as to prevent the pipe unit 50 from being detached from the valve seat 30. Finally, the bottom cover 132 is locked onto the open bottom of the water outlet portion 13 by the fastening screws 131 to cover the water outlet portion 13 of the housing 10.

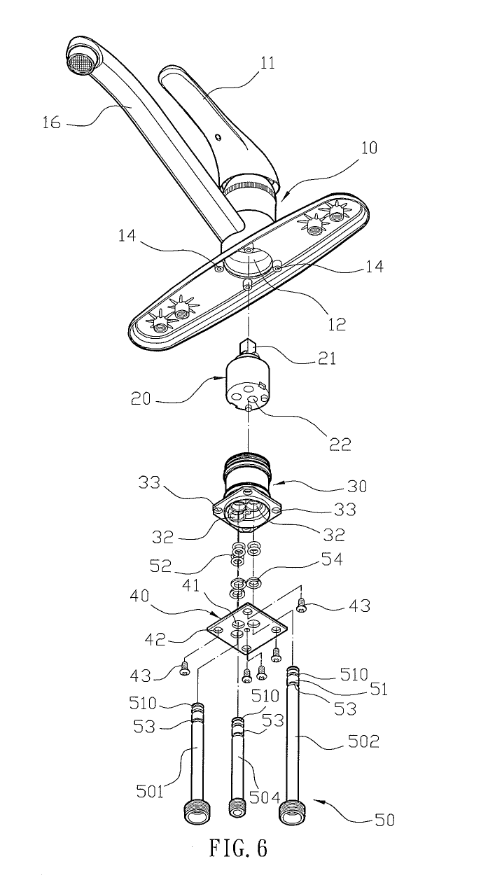

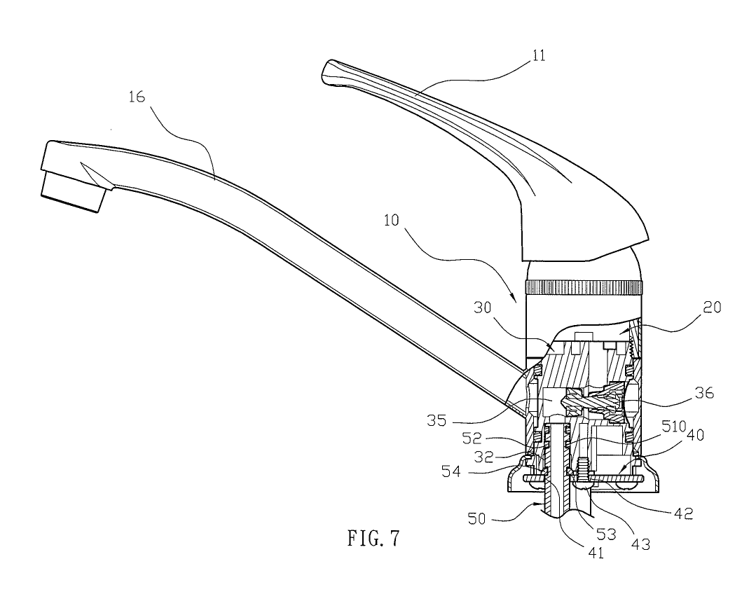

Referring to FIGS. 6 and 7, in accordance with another preferred embodiment of the present invention, the housing 10 has a side provided with a water outlet pipe 16 connected to the receiving space 12. The valve seat 30 has an inner portion provided with a water channel 35 for mounting a check valve 36. The water channel 35 of the valve seat 30 is connected between the guide hole 32 of the valve seat 30 and the water inlet hole 22 of the water control valve 20. The pipe unit 50 includes a hot water inlet pipe 501, a cold water inlet pipe 502 and a shower head outlet pipe 504 each extended through a respective one of the through holes 41 of the fixing plate 40 into a respective one of the guide holes 32 of the valve seat 30.

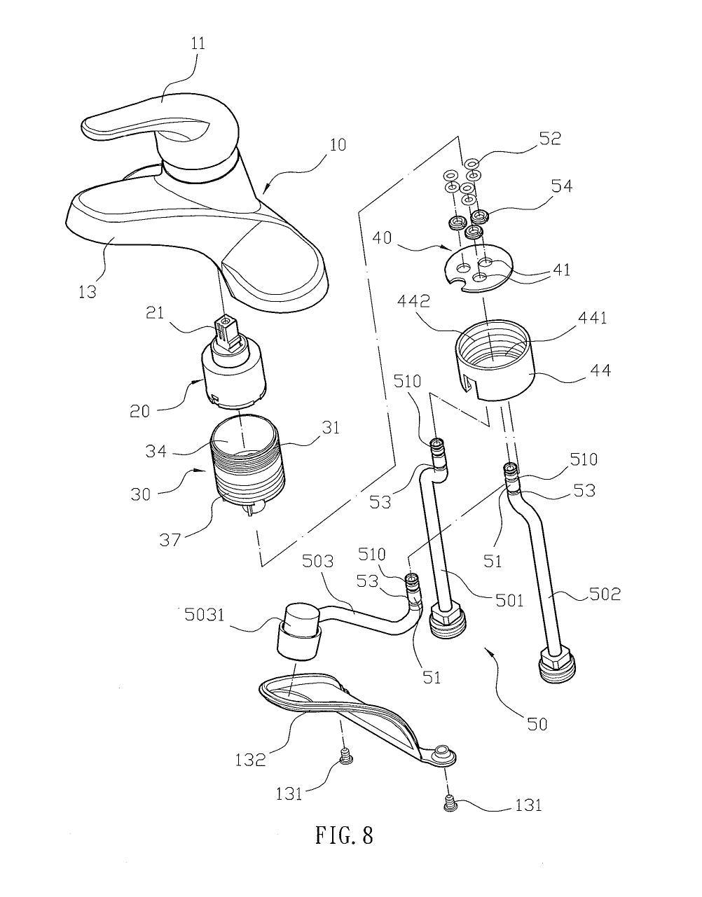

Referring to FIG. 8, the faucet further comprises a locking sleeve 44 abutting the fixing plate 40 and locked onto the valve seat 30 to attach the fixing plate 40 to the valve seat 30. The valve seat 30 has an outer wall provided with an external thread 37. The locking sleeve 44 has an inner wall provided with an internal thread 442 screwed onto the external thread 37 of the valve seat 30 so that the locking sleeve 44 is locked onto the valve seat 30. The locking sleeve 44 has an end portion provided with a limit flange 441 abutting the fixing plate 40 so that the fixing plate 40 is limited in the locking sleeve 44 and is located between the valve seat 30 and the limit flange 441 of the locking sleeve 44. The limit flange 441 of the locking sleeve 44 extends radially and inward from the end portion of the locking sleeve 44.

Accordingly, the end portion 51 of the pipe unit 50 is extended through the through hole 41 of the fixing plate 40 and is inserted into the guide hole 32 of the valve seat 30 so that the pipe unit 50 is connected with the valve seat 30 easily and quickly, thereby facilitating a user assembling the pipe unit 50 and the valve seat 30. In addition, the retaining member 54 is located between the valve seat 30 and the fixing plate 40 to affix the pipe unit 50 to the fixing plate 40 so that the pipe unit 50 is directly inserted into the valve seat 30 to decrease the working process of the valve seat 30 and to decrease the costs of fabrication. Further, the retaining member 54 is mounted in the retaining groove 53 of the pipe unit 50 and is located between the valve seat 30 and the fixing plate 40 so that the retaining member 54 can connect the valve seat 30 and the pipe unit 50 of different material. Further, the housing 10, the valve seat 30 and the fixing plate 40 are combined together by the locking bolts 43 so that the valve seat 30 and the pipe unit 50 of different material are positioned by the retaining member 54 without needing a secondary working process.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A faucet, comprising:
a housing having an inner portion provided with a receiving space;
a fixing plate affixed to the housing;
a valve seat mounted in the receiving space of the housing and located between the housing and the fixing plate;
a water control valve mounted between the housing and the valve seat;
a pipe unit extended through the fixing plate and connected with the valve seat; and
at least one retaining member secured on the pipe unit and located between the valve seat and the fixing plate to affix the pipe unit to the fixing plate so as to prevent the pipe unit from being detached from the valve seat.

2. The faucet of claim 1, wherein
the receiving space of the housing has a rim provided with a plurality of screw bores;
the valve seat has an end portion provided with at least one guide hole to allow insertion of the pipe unit;
the valve seat has a rim provided with a plurality of locking holes aligning with the screw bores of the housing respectively;
the fixing plate is made of metallic material;
the fixing plate has a surface provided with at least one through hole aligning with the guide hole of the valve seat to allow passage of the pipe unit;
the fixing plate has a periphery provided with a plurality of fixing holes aligning with the locking holes of the valve seat respectively;
the faucet further comprises a plurality of locking bolts in turn extended through the fixing holes of the fixing plate and the locking holes of the valve seat respectively and screwed into the screw bores of the housing respectively so that the housing, the valve seat and the fixing plate are combined together by the locking bolts;
the pipe unit is extended through the through hole of the fixing plate into the guide hole of the valve seat;
the pipe unit has an end portion which is extended through the through hole of the fixing plate and is fully inserted into the guide hole of the valve seat;
the end portion of the pipe unit has a surface provided with at least one annular mounting groove for mounting at least one O-ring which is inserted into the guide hole of the valve seat and biased between the end portion of the pipe unit and the guide hole of the valve seat to provide an air-tight effect between the pipe unit and the valve seat;
the end portion of the pipe unit has a periphery provided with a retaining groove for mounting the retaining member;
the water control valve is located between the receiving space of the housing and the receiving chamber of the valve seat;
the water control valve has a first end provided with a control shaft and a second end provided with at least one water inlet hole aligning with and connected to the guide hole of the valve seat;
the guide hole of the valve seat is connected between the water inlet hole of the water control valve and the pipe unit so that the pipe unit is connected to the water inlet hole of the water control valve through the guide hole of the valve seat.

3. The faucet of claim 1, wherein the faucet further comprises a locking sleeve abutting the fixing plate and locked onto the valve seat to attach the fixing plate to the valve seat.

4. The faucet of claim 3, wherein
the valve seat has an outer wall provided with an external thread;
the locking sleeve has an inner wall provided with an internal thread screwed onto the external thread of the valve seat so that the locking sleeve is locked onto the valve seat;
the locking sleeve has an end portion provided with a limit flange abutting the fixing plate;
the fixing plate is limited in the locking sleeve;
the fixing plate is located between the valve seat and the limit flange of the locking sleeve;
the limit flange of the locking sleeve extends radially and inward from the end portion of the locking sleeve.

5. The faucet of claim 2, wherein
the housing has a side provided with a water outlet portion connected to the receiving space;
the water outlet portion of the housing has an open bottom;
the faucet further comprises a bottom cover mounted on the open bottom of the water outlet portion by a plurality of fastening screws to cover the water outlet portion of the housing;
the receiving space of the housing has a peripheral wall provided with an inner threaded portion;
the valve seat has a peripheral wall provided with an outer threaded portion screwed into the inner threaded portion of the housing to lock the valve seat in the receiving space of the housing;
the valve seat has three guide holes;
the water control valve has three water inlet holes aligning with the guide holes of the valve seat respectively;
the fixing plate has three through holes aligning with the guide holes of the valve seat respectively;
the pipe unit includes a hot water inlet pipe, a cold water inlet pipe and a mixed water outlet pipe each extended through a respective one of the through holes of the fixing plate into a respective one of the guide holes of the valve seat;
the mixed water outlet pipe of the pipe unit has a distal end provided with an aerator mounted in the water outlet portion of the housing and partially protruded outward from the bottom cover;
the faucet comprises three retaining members secured on the hot water inlet pipe, the cold water inlet pipe and the mixed water outlet pipe of the pipe unit respectively.

6. The faucet of claim 1, wherein the valve seat has an inner portion provided with a receiving chamber connected to the receiving space of the housing to receive the water control valve.

7. The faucet of claim 2, wherein
the retaining groove of the pipe unit has an annular shape;
the retaining member has an annular shape;
the retaining member is located between the guide hole of the valve seat and the through hole of the fixing plate;
the retaining member has a size greater than that of the guide hole of the valve seat and greater than that of the through hole of the fixing plate.

8. The faucet of claim 2, wherein
the valve seat has three guide holes;
the water control valve has three water inlet holes aligning with the guide holes of the valve seat respectively;
the fixing plate has three through holes aligning with the guide holes of the valve seat respectively;
the pipe unit includes a hot water inlet pipe, a cold water inlet pipe and a shower head outlet pipe each extended through a respective one of the through holes of the fixing plate into a respective one of the guide holes of the valve seat.

9. The faucet of claim 8, wherein
the housing has a side provided with a water outlet pipe connected to the receiving space;
the valve seat has an inner portion provided with a water channel for mounting a check valve;
the water channel of the valve seat is connected between the guide hole of the valve seat and the water inlet hole of the water control valve.
